(19) United States
(12) Patent Application Publication
(10) Pub. No.: US 2025/0018719 A1
(43) Pub. Date: Jan. 16, 2025

(54) PRINTING APPARATUS

(71) Applicant: CANON KABUSHIKI KAISHA, Tokyo (JP)

(72) Inventors: TETSUJI SUZUKI, Kanagawa (JP); SEIJI SUZUKI, Kanagawa (JP); RYOSUKE ARAKI, Kanagawa (JP)

(21) Appl. No.: 18/763,293

(22) Filed: Jul. 3, 2024

(30) Foreign Application Priority Data
Jul. 14, 2023 (JP) 2023-115851

(51) Int. Cl. B41J 2/175; B41J 2/155; B41J 2/17; B41J 29/00

(52) U.S. Cl. CPC B41J 2/175; B41J 2/155; B41J 2/1721; B41J 29/00

(57) ABSTRACT

A printing unit configured to eject liquid; a storage unit configured to store liquid; a moving unit configured to be movable the storage unit; and a support unit configured to support a channel connected to the storage unit, and configured to be deformable in accordance with movement of the moving unit are included. The support unit includes a fixing part is fixed to the printing apparatus and a deformable part of which one end is connected to the fixing part and the other end is fixed to the moving unit, the deformable part being configured to extend from one side to the other side of the movement direction and then curve at a predetermined curvature and fold from the other side to the one side, so as to extend in an overlapping manner with the fixing unit in a direction of gravity.

### BACKGROUND OF THE INVENTION

### Field of the Invention

The present invention relates to a printing apparatus that performs printing by ejecting ink.

### Description of the Related Art

Inkjet printing apparatuses that perform printing by ejecting ink onto a print medium with a print head include an ink tank that stores ink to be supplied to the print head and a waste liquid tank that collects waste ink generated during recovery operations performed for the print head.

Japanese Patent Laid-Open No. 2013-086438 discloses a technology in which a valve mechanism is installed at a connection part between an apparatus and a waste liquid tank, so that the valve mechanism is brought into an opened state at the time the waste liquid tank is retracted, and the valve mechanism is brought into a tightly closed state at the time of replacing the waste liquid tank, thereby suppressing leakage of waste ink at the time of replacing the waste liquid tank.

However, with the technology disclosed in Japanese Patent Laid-Open No. 2013-086438, in a case of using ink that easily solidifies upon contact with the atmosphere, the valve mechanism, which is a connection part between the apparatus and the waste liquid tank, may not function properly due to solidification of the ink, and there has been a possibility that waste ink leaks out inside the apparatus.

To address these concerns, it is conceivable that the waste liquid tank is pulled out of the apparatus so that the waste liquid tank is replaced outside the apparatus. However, in this case, at the time of pulling the waste liquid tank out of the apparatus and at the time of retracting the waste liquid tank into the apparatus, there has been a possibility that a waste liquid tube that guides waste ink to the waste liquid tank is pinched by other members or bends, and becomes blocked, resulting in ink leakage inside the apparatus.

### SUMMARY OF THE INVENTION

The present invention was made in view of the above-mentioned problems, so as to provide a technology that ensures workability at the time of replacing a tank that stores liquid, such as ink, and is capable of suppressing leakage of the liquid inside the apparatus.

A printing apparatus that performs printing by ejecting liquid to a print medium includes: a printing unit configured to eject the liquid; a storage unit configured to store the liquid; a moving unit on which the storage unit is placed in a replaceable manner, and which is configured to be movable between a replacement position, where the storage unit can be replaced, and a retracted position, where the storage unit is retracted inside the printing apparatus; and a support unit configured to support a channel connected to the storage unit, and configured to be deformable in accordance with movement of the moving unit, wherein the support unit includes a fixing part that extends in a movement direction of the moving unit and is fixed to the printing apparatus and a deformable part of which one end is connected to the fixing part and the other end is fixed to the moving unit, the deformable part being configured to extend from one side to the other side of the movement direction and then curve at a predetermined curvature and fold from the other side to the one side, so as to extend in an overlapping manner with the fixing unit in a direction of gravity.

According to the present invention, it is possible to ensure workability at the time of replacing a tank that stores liquid, such as ink, and suppress leakage of the liquid inside an apparatus.

Further features of the present invention will become apparent from the following description of exemplary embodiments with reference to the attached drawings.

### BRIEF DESCRIPTION OF THE DRAWINGS

FIG. 1 is a schematic configuration diagram of a printing apparatus;

FIG. 2 is a perspective view of a print head;

FIG. 3 is a perspective view of a cap part;

FIG. 4 is a perspective view of a cleaning part;

FIG. 5 is a diagram illustrating channels connected to a maintenance part;

FIG. 6 is a perspective view of a waste liquid reservoir part in a retracted position;

FIG. 7 is an external view of the apparatus in the vicinity of the waste liquid reservoir part in the retracted position;

FIG. 8 is a perspective view of a waste ink tank and waste liquid tank;

FIG. 9 is a perspective configuration diagram of a channel support member;

FIG. 10 is a perspective view of the waste liquid reservoir part in a replacement position;

FIG. 11 is an external view of the apparatus in the vicinity of the waste liquid reservoir part in the replacement position; and

FIG. 12 is a diagram illustrating a modification example of the waste liquid reservoir part.

### DESCRIPTION OF THE EMBODIMENTS

Hereinafter, with reference to the accompanying drawings, a detailed explanation is given of an example of embodiments of a printing apparatus. Note that the following embodiments are not intended to limit the present invention, and each combination of the characteristics explained in the present embodiments is not necessarily essential to the solution provided in the present invention. Further, the positions, shapes, etc., of the constituent elements described in the embodiments are merely examples and are not intended to limit the range of this invention to that of the examples.

### (Configuration of the Printing Apparatus)

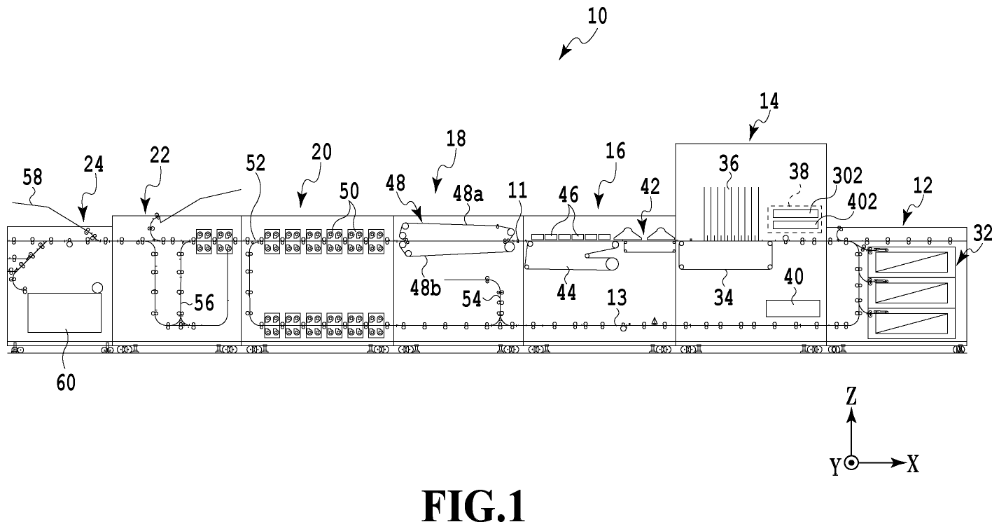

The printing apparatus according to the present embodiment may be an apparatus equipped only with the function of printing an image by ejecting ink onto a print medium, or may be a multifunction peripheral equipped with the functions of reading an image and the like. In the following explanation, a large inkjet printing apparatus such as a commercial printer is used as an example. Further, in the explanation of the present specification, for the user facing the printing apparatus (facing the surface illustrated in FIG. 1), the direction from the left side to the right side of the apparatus is the X direction, the direction from the rear side to the near side is the Y direction, and the direction from the lower side to the upper side is the Z direction. In this way, the X direction, the Y direction, and the Z direction are directions from one side to the other side, and are denoted with “+ (plus)” as appropriate, and for each direction, the direction from the other side to one side is denoted with “− (minus)”.

FIG. 1 is a schematic configuration diagram of the printing apparatus according to the present embodiment. The printing apparatus 10 is a sheet-fed type inkjet printing apparatus capable of printing images on multiple sizes of sheets S using ink and a reaction liquid that reacts with the ink. The printing apparatus 10 includes the feeding module 12 that accommodates multiple sizes of sheets S and feeds the accommodated sheets S, and the print module 14 that performs printing on the sheets S fed by the feeding module 12. Further, the printing apparatus 10 includes the drying module 16 that dries the ink and reaction liquid on the sheet S printed in the print module 14, and the fixing module 18 that fixes the ink on the sheet S. Furthermore, the printing apparatus 10 includes the cooling module 20 that cools the sheet S, the flipping module 22 that flips the sheet S, and the stacking module 24 where the sheet S is discharged and stacked.

The printing apparatus 10 includes a control part (not illustrated in the drawings) that controls the overall operation. In the printing apparatus 10, while the cut paper sheets S fed from the feeding module 12 are conveyed in the conveyance path configured in each module, processing is executed so that the sheets are discharged to the stacking module 24 with images printed thereon. Note that the conveyance path installed in the printing apparatus 10 includes the conveyance path 11 for executing processing in each module and the conveyance path 13 for returning the sheet S that has been printed on one side to the feeding module 12 in a case of double-sided printing. Note that the conveyance path 13 merges with the conveyance path 11 in the feeding module 12 and the cooling module 20. Hereinafter, an explanation is given about each module.

### <Feeding Module>

The feeding module 12 includes the accommodation cabinet 32 for accommodating the sheets S. The accommodation cabinet 32 is configured to be movable in the Y direction and can be pulled out in the +Y direction from the state of being retracted in the printing apparatus 10, thereby allowing the sheets S to be accommodated therein. Further, the accommodation cabinet 32 is pushed into the printing apparatus 10 in the −Y direction from the pulled-out state, so as to be in the state capable of feeding the accommodated sheets S. In the present embodiment, there are three accommodation cabinets 32, but there is no limitation as such, and there may be one or two or even four or more accommodation cabinets 32. The sheets S accommodated in the accommodation cabinet 32 are fed one by one to the print module 14 by a separation belt (not illustrated in the drawings) and a feed roller (not illustrated in the drawings).

### <Print Module>

The print module 14 includes a pre-printing registration correction part (not illustrated in the drawings), the belt part 34, and the print heads 36. The pre-printing registration correction part corrects the inclination and position of the sheet S fed from the feeding module 12. The belt part 34 conveys the sheet S whose inclination, etc., have been corrected by the pre-printing registration correction part. The print heads 36 are arranged at positions facing the sheet S conveyed by the belt part 34. The belt part 34 is configured to be capable of absorbing and conveying the sheet S, thereby maintaining a constant distance between the print heads 36 and the sheet S. The print heads 36 eject ink from the upper side onto the sheet S conveyed by the belt part 34, thereby applying ink (reaction liquid) to the sheet S to print an image.

The print heads 36 include multiple nozzles capable of ejecting ink (reaction liquid) by an inkjet system. Further, in the print heads 36, the multiple nozzles are arranged in arrays in a length corresponding to the width of the sheet S that can be printed by the printing apparatus 10 in the width direction (the Y direction) of the sheet S, which intersects with the conveyance direction of the sheet S (the −X direction). Furthermore, the print heads 36 are installed individually for the respective types of ink and reaction liquid, and each print head 36 is arranged in an array along the X direction. The print heads 36 are configured to eject ink by various known inkjet systems using heating elements, piezoelectric elements, electrostatic elements, or MEMS elements.

The present embodiment includes a print head that ejects yellow (Y) ink, a print head that ejects magenta (M) ink, a print head that ejects cyan (C) ink, a print head that ejects black (Bk) ink, and a print head that ejects reaction liquid (R). That is, in the present embodiment, the printing apparatus 10 includes five print heads 36. Note that, in the present embodiment, the printing apparatus 10 is configured with the ability of ejecting the four types of ink and one type of reaction liquid, but there is no limitation as such. In other words, a configuration to eject one, two, three, or five or more types of ink, a configuration to eject no reaction liquid, and a configuration to eject two or more types of reaction liquid are also possible.

Note that, to each print heads 36, an ink tank (not illustrated in the drawings) that stores the corresponding type of ink or reaction liquid is connected via a tube. Furthermore, each of the print heads 36 is supplied with the ink or reaction liquid stored in the connected ink tank. Note that the ink tanks are arranged so as to be removable from the printing apparatus 10.

The print module 14 may be equipped with an in-line scanner (not illustrated in the drawings), for example, on the downstream side of the print heads 36 in the conveyance direction (−X direction). In this case, the printing apparatus 10 uses this in-line scanner to detect the misalignment and color density of the image printed on the sheet S, and corrects the printed image based on the detection results.

Further, the print module 14 includes the maintenance part 38 which is equipped with a configuration to maintain and recover good ink ejection characteristics of the print heads 36, and the waste liquid reservoir part 40 which stores waste liquid generated in recovery operations performed by the maintenance part 38 for the print heads 36. Although the details are described later, the maintenance part 38 includes a configuration to protect the nozzle surfaces on which the nozzles are formed in the print heads 36, a configuration to wipe the nozzle surfaces, a configuration to suction the ink inside the nozzles, and the like. Note that the configurations installed in the maintenance part 38 are not limited as such, and various known configurations to perform recovery operations on the print heads 36 may be installed.

The maintenance part 38 is configured to be movable in the X direction, so as to be movable between the stand-by position (the position illustrated in FIG. 1) that does not overlap with the print heads 36 in the X direction and the operating position directly below the print heads 36 where recovery operations for the print heads 36 are performed. Note that the print heads 36 are configured to be movable in the Z direction, so as to be movable between the printing position (the position illustrated in FIG. 1) for printing on the sheet S conveyed by the belt part 34 and the recovery position where recovery operations are executed by the maintenance part 38 in the operating position.

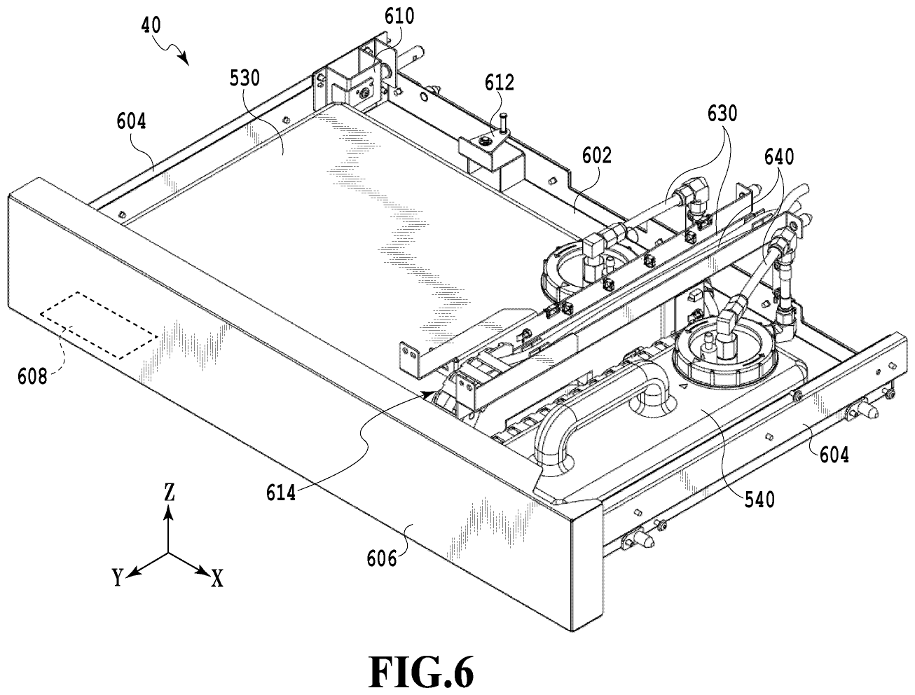

In the waste liquid reservoir part 40, the waste ink tank 530 (see FIG. 6) that can store waste ink and the waste liquid tank 540 (see FIG. 6) that can store waste reaction liquid are placed in a replaceable manner. Further, the waste liquid reservoir part 40 is configured to be movable in the Y direction, so as to be movable between the retracted position, where the waste liquid reservoir part 40 is retracted inside the printing apparatus 10, and the replacement position, where the waste liquid reservoir part 40 is pulled out of the printing apparatus 10 so that the waste ink tank 530 and the waste liquid tank 540 can be replaced. Details of the waste liquid reservoir part 40 are described below.

### <Drying Module>

The drying module 16 executes a process to reduce the liquid component contained in the ink applied on the sheet S by the print heads 36 for improving the fixability between the sheet S and the ink. The drying module 16 includes the decoupling part 42, the belt part 44, and the warm air blowing part 46. The sheet S printed by the print module 14 is conveyed to the decoupling part 42 in the drying module 16.

The decoupling part 42 can convey the sheet S by wind pressure from the upper side and friction of the belt, and holds the sheet S on the belt gently by wind pressure for the conveyance, thereby suppressing displacement of the sheet S conveyed from the print module 14. The belt part 44 absorbs and conveys the sheet S conveyed from the decoupling part 42. The warm air blowing part 46 is placed on the upper side of the belt part 44, and blows warm air on the sheet S conveyed by the belt part 44 to dry the ink applied to the printing surface of the sheet S facing the warm air blowing part 46. Note that the drying system in the drying module 16 is not limited to the system using warm air, and for example, a system in which the printing surface of the sheet S is irradiated with electromagnetic waves (ultraviolet rays, infrared rays, etc.), or a conduction heat transfer system by contacting a heat generation member may be used. Alternatively, a combination of these systems may be used.

### <Fixing Module>

The fixing module 18 includes the fixing belt part 48. The fixing belt part 48 is configured with the ability of conveying the sheet S in the −X direction while nipping the sheet S between the heated upper belt 48a and the lower belt 48b. The sheet S conveyed from the drying module 16 is nipped between the upper belt 48a and the lower belt 48b during conveyance. Accordingly, the ink applied to the printing surface of the sheet S is fixed to the printing surface.

### <Cooling Module>

The cooling module 20 includes the multiple cooling parts 50 that cool the sheet S, so as to cool the sheet S conveyed from the fixing module 18. The cooling parts 50 use a fan (not illustrated in the drawings) to draw outside air into a cooling box (not illustrated in the drawings), so as to increase the pressure inside the cooling box, and then blow the air inside the cooling box against the sheet S conveyed in the conveyance path 11 to cool the sheet S. Further, the cooling parts 50 are arranged on the upper side and lower side of the conveyance path 11, so as to be capable of cooling the sheet S from both sides.

The cooling module 20 includes the switching part 52 that switches the conveyance path. The switching part 52 can switch the conveyance path of the conveyed sheet S to either the conveyance path 11 or the conveyance path 13. If the conveyance path is switched by the switching part 52, the sheet S conveyed in the cooling module 20 proceeds from the switching part 52 to the conveyance path 13, so as to be conveyed to the feeding module 12. Further, if the switching by the switching part 52 is not performed, the sheet S conveyed in the cooling module 20 is conveyed from the cooling module 20 to the flipping module 22.

During double-sided printing, the sheet S is conveyed to the conveyance path 13, and via the cooling module 20, the fixing module 18, the drying module 16, and the print module 14, up to the feeding module 12. The sheet S that has been conveyed through the conveyance path 13 to the feeding module 12 is conveyed to the conveyance path 11 again, so as to be printed by the print module 14. Note that the fixing module 18 includes the flipping part 54 that flips the front and back of the sheet S in the conveyance path 13.

### <Flipping Module>

The flipping module 22 includes the flipping part 56 that flips the front and back of the sheet S conveyed from the cooling module 20. For the sheet S discharged by the stacking module 24, the flipping part 56 of the flipping module 22 can change the side that faces upward at the time of stacking.

### <Stacking Module>

The stacking module 24 includes the top tray 58 installed on the upper side of the stacking module 24, and the stacking part 60 installed inside the stacking module 24. In the printing apparatus 10, it is possible to select either the top tray 58 or the stacking part 60 as the discharge destination of the sheets S.

### (Configuration of the Print Heads)

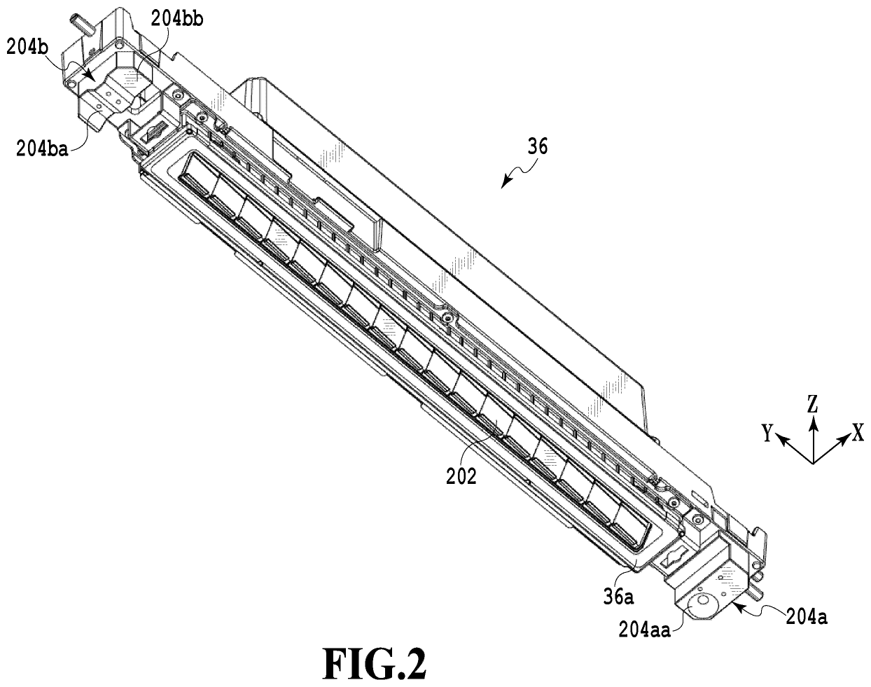

Next, an explanation is given about the configuration of the print heads 36. FIG. 2 is a perspective view of the print head 36.

In the print head 36, the nozzle plates 202, in which multiple nozzles capable of ejecting ink are arranged in arrays, are arranged in an array in the Y direction on the surface (nozzle surface) 36a that faces the sheet S conveyed by the belt part 34. In the print head 36, the nozzle plates 202 are arranged so that the nozzle arrays are formed for a length corresponding to the length of the sheet S in the width direction (Y direction) that can be printed by the printing apparatus 10.

Further, in the print head 36, the positioning parts 204a and 204b are formed near both ends in the Y direction, so as to position the print head 36 with respect to the configuration of the maintenance part 38. In the print head 36, one concave part 204aa is formed in the positioning part 204a, which is to be located on one side of the Y direction, i.e., the back side, at the time of being mounted on the printing apparatus 10. Further, in the print head 36, two concave parts 204ba and 204bb are formed in the positioning part 204b, which is to be located on the other side of the Y direction, i.e., the front side, at the time of being mounted on the printing apparatus 10. The two concave parts 204ba and 204bb are formed side by side in the X direction.

Note that the concave part 204aa is formed to be engageable with the later-described convex parts 306a and 416a, and the concave parts 204ba and 204bb are formed to be engageable with the later-described convex parts 306b and 416b. Further, the shapes of the concave parts 204aa, 204ba, and 204bb may be different from each other or the same shape.

### (Configuration of the Maintenance Part)

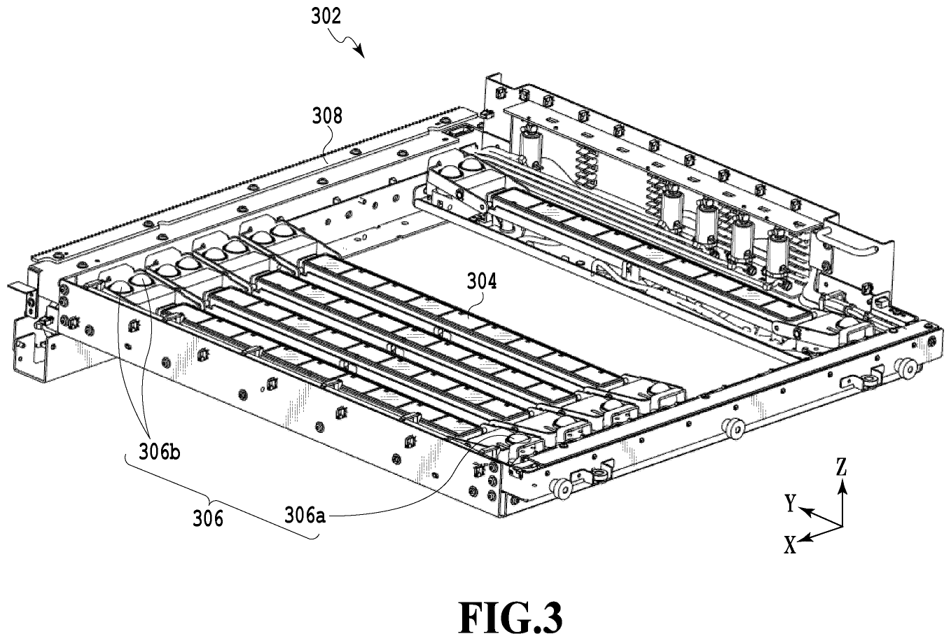

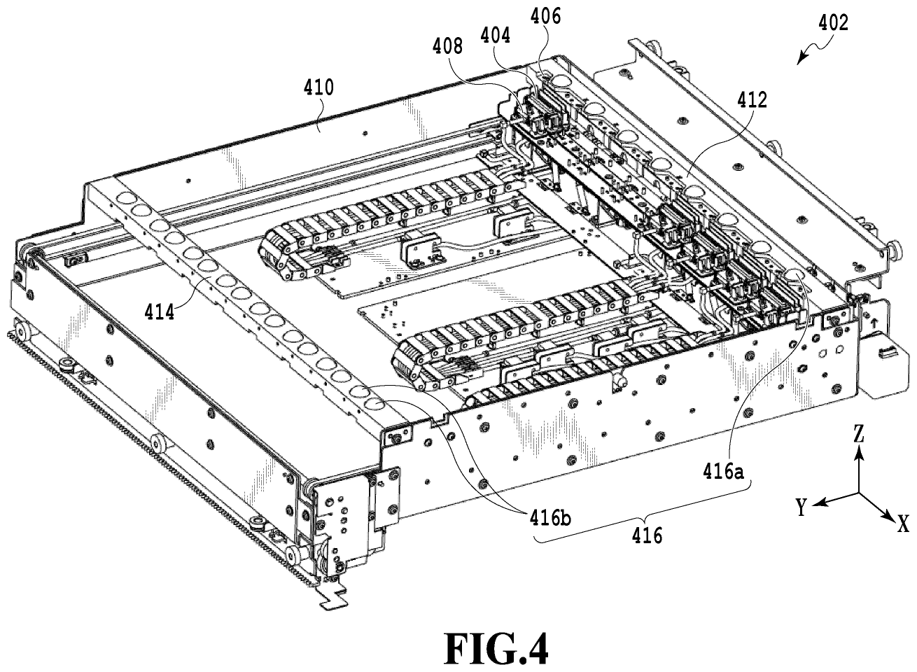

Next, an explanation is given about the maintenance part 38. FIG. 3 is a perspective view of the cap part 302 installed in the maintenance part 38. FIG. 4 is a perspective view of the cleaning part 402 installed in the maintenance part 38.

The maintenance part 38 includes the cap part 302 for protecting the nozzle surfaces 36a of the print heads 36, and the cleaning part 402 that can execute wiping of the nozzle surfaces 36a of the print heads 36 and suctioning of ink from the nozzles. In the maintenance part 38, the cap part 302 and the cleaning part 402 are independently movable in the X direction and are configured to move between the stand-by position and the operating position.

### <Configuration of the Cap Part>

The cap part 302 includes the caps 304 that protect the nozzle surfaces 36a of the corresponding print heads 36, and the support member 308 that supports the caps 304 (see FIG. 3). The support member 308 is placed in a slidable manner on a rail (not illustrated in the drawings) installed in the housing of the printing apparatus 10, and is configured to be movable in the X direction by the driving of a drive motor (not illustrated in the drawings).

Further, the cap part 302 includes the positioning part 306 for positioning the print head 36 with respect to the cap 304 at both ends of each cap 304 in the Y direction. The positioning part 306 includes the convex part 306a that can engage with the concave part 204aa of the positioning part 204a, which is installed on the print head 36 on one side of the Y direction, i.e., on the back side, at the time the maintenance part 38 is placed in the printing apparatus 10. Further, the positioning part 306 includes two convex parts 306b that can engage with the concave parts 204ba and 204bb of the positioning part 204b, which is installed on the print head 36 on the other side of the Y direction, i.e., on the front side, at the time the maintenance part 38 is placed in the printing apparatus 10. The two convex parts 306b are arranged side by side in the X direction.

The cap part 302 is configured to allow the cap 304 to be raised and lowered together with the positioning part 306 by the support member 308. With the cap part 302 in the operating position and the print head 36 in the recovery position, for example, the cap 304 is raised. This allows the nozzle surface 36a to be capped with the cap 304 while the cap 304 is positioned with respect to the print head 36 by the positioning parts 204a and 204b of the print head 36 and the positioning part 306 of the cap part 302.

The cap part 302 caps the nozzle surface 36a of the print head 36 with the cap 304, so as to protect the nozzle surface 36a. Further, the cap part 302 is configured so that the inside of the cap 304 can be depressurized, and configured to be capable of suctioning ink from each nozzle by depressurizing the inside of the cap 304 with the nozzle surface 36a being capped.

### <Configuration of the Cleaning Part>

The cleaning part 402 includes the liquid application part 404 that applies cleaning liquid to the nozzle surface 36a of the print head 36, and the removal part 406 for wiping off and removing ink, paper dust, cleaning liquid, etc., adhered to the nozzle surface 36a (see FIG. 4). Further, the cleaning part 402 includes the negative pressure application part 408 that applies negative pressure to the nozzle surface 36a, so as to remove ink that has solidified or thickened near the nozzles and inside the nozzles and to remove bubbles that have formed inside the nozzles. Note that the liquid application part 404, the removal part 406, and the negative pressure application part 408 are each installed for each print head 36 in the support member 410, and are configured to be movable in the Y direction. In the printing apparatus 10, the recovery operation on the nozzle surfaces 36a of the print heads 36 is performed by combinations of the liquid application parts 404, the removal parts 406, and the negative pressure application parts 408.

In the cleaning part 402, the support member 410 includes the beam members 412 and 414 extending in the X direction in the vicinity of both ends in the Y direction. The beam members 412 and 414 are equipped with the positioning part 416 that functions together with the positioning parts 204a and 204b of the print head 36 to position the liquid application part 404, the removal part 406, and the negative pressure application part 408 with respect to the print head 36. Specifically, the beam member 412 includes the convex part 416a that can engage with the concave part 204aa of the positioning part 204a installed on the print head 36. Further, the beam member 414 includes two convex parts 416b that can engage with the concave parts 204ba and 204bb of the positioning part 204b of the print head 36.

### (Configurations of the Channels)

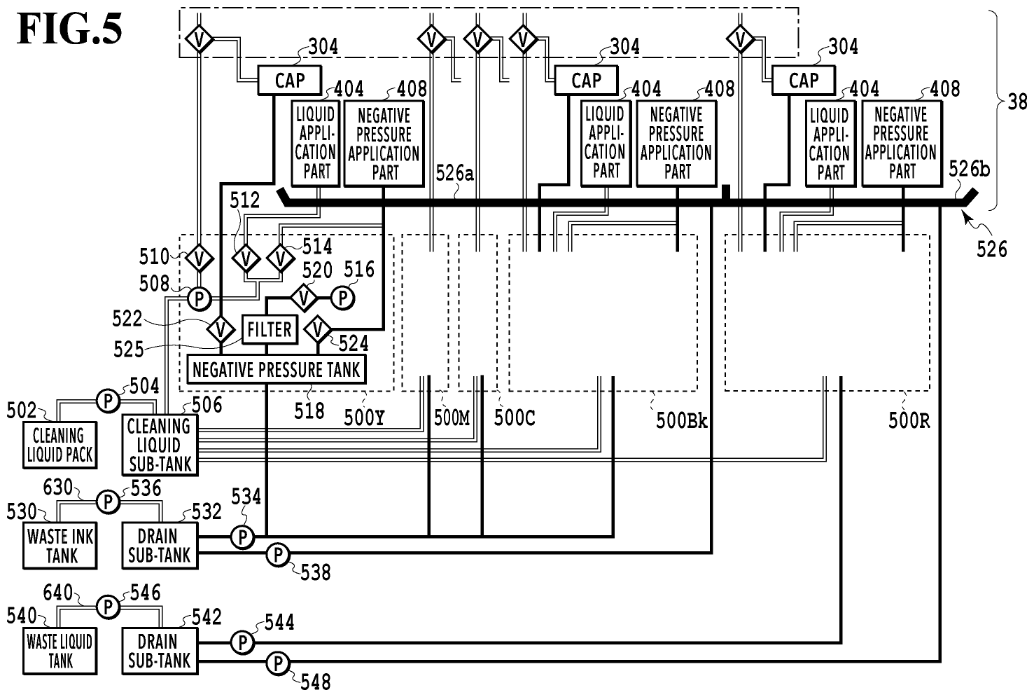

Next, an explanation is given about the channels connected to the maintenance part 38. FIG. 5 is a diagram illustrating the various channels connected to the maintenance part 38. Note that, in FIG. 5, illustration of some configurations are omitted for ease of understanding.

The printing apparatus 10 includes the supply unit 500 for supplying cleaning liquid and applying negative pressure to the cleaning part 402. The supply unit 500 is installed independently of the configuration of the maintenance part 38 corresponding to each print head 36. That is, the supply unit 500 includes the supply unit 500Y connected to the cap 304, liquid application part 404, and negative pressure application part 408 corresponding to the print head 36 that ejects Y ink. Further, the supply unit 500 includes the supply unit 500M connected to the cap 304, liquid application part 404, and negative pressure application part 408 corresponding to the print head 36 that ejects M ink. Furthermore, the supply unit 500 includes the supply unit 500C connected to the cap 304, liquid application part 404, and negative pressure application part 408 corresponding to the print head 36 that ejects C ink. Moreover, the supply unit 500 includes the supply unit 500Bk connected to the cap 304, liquid application part 404, and negative pressure application part 408 corresponding to the print head 36 that ejects Bk ink. Further, the supply unit 500 includes the supply unit 500R connected to the cap 304, liquid application part 404, and negative pressure application part 408 corresponding to the print head 36 that ejects reaction liquid.

Note that, in FIG. 5, since the configuration of each supply unit 500 is the same as each other, the internal configuration is illustrated for the supply unit 500Y, and illustration of the internal configuration is omitted for the other supply units 500. Further, in FIG. 5, illustration of the caps 304, liquid application parts 404, and negative pressure application parts 408 is also omitted for two print heads 36.

In the printing apparatus 10, the cleaning liquid pack 502 that stores cleaning liquid to be supplied to the maintenance part 38 is placed in a removable manner. The cleaning liquid stored in the cleaning liquid pack 502 is transferred by the pump 504 to the cleaning liquid sub-tank 506. Furthermore, the liquid can be transferred from the cleaning liquid sub-tank 506 to the cap 304, the liquid application part 404, and the negative pressure application part 408 by the supply pump 508 installed in each supply unit 500. Note that the timings of supplying the cleaning liquid to the cap 304 are controlled by the open/close valve 510 installed between the supply pump 508 and the cap 304. Further, the timings of supplying the cleaning liquid to the liquid application part 404 are controlled by the open/close valve 512 installed between the supply pump 508 and the liquid application part 404. Furthermore, the timings of supplying the cleaning liquid to the negative pressure application part 408 are controlled by the open/close valve 514 installed between the supply pump 508 and the negative pressure application part 408.

Each supply unit 500 includes the negative pressure tank 518 that is internally depressurized by the suction pump 516 and can store waste ink (waste reaction liquid) suctioned from the connected cap 304 and negative pressure application part 408. Note that the filter 525 is installed between the suction pump 516 and the negative pressure tank 518. The negative pressure tank 518 is connected to the cap 304 and the negative pressure application part 408. Therefore, negative pressure can be applied to the cap 304 and the negative pressure application part 408 by driving the suction pump 516. Note that the application of negative pressure to the cap 304 is controlled by the open/close valve 520 installed between the suction pump 516 and the negative pressure tank 518 and the open/close valve 522 installed between the negative pressure tank 518 and the cap 304. Further, the application of negative pressure to the negative pressure application part 408 is controlled by the open/close valve 520 and the open/close valve 524 installed between the negative pressure tank 518 and the negative pressure application part 408.

The printing apparatus 10 includes the drain sub-tank 532 connected to the waste ink tank 530, which is retracted in the waste liquid reservoir part 40 in a replaceable manner. The drain sub-tank 532 is connected to the negative pressure tank 518 of the supply units 500Y, 500M, 500C, and 500Bk. The pump 534 is installed between the drain sub-tank 532 and the negative pressure tank 518, so that the waste ink in the negative pressure tank 518 of each supply unit 500 can be transferred to the drain sub-tank 532 by the driving of the pump 534. Further, the waste ink stored in the drain sub-tank 532 can be transferred to the waste ink tank 530 by the pump 536 installed between the drain sub-tank 532 and the waste ink tank 530.

Further, the printing apparatus 10 includes the drain sub-tank 542 connected to the waste liquid tank 540, which is retracted in the waste liquid reservoir part 40 in a replaceable manner. The drain sub-tank 542 is connected to the negative pressure tank 518 of the supply unit 500R. The pump 544 is installed between the drain sub-tank 542 and the negative pressure tank 518, so that the waste reaction liquid in the negative pressure tank 518 of the supply unit 500R can be transferred to the drain sub-tank 542 by the driving of the pump 544. Further, the waste reaction liquid stored in the drain sub-tank 542 can be transferred to the waste liquid tank 540 by the pump 546 installed between the drain sub-tank 542 and the waste liquid tank 540.

Furthermore, the maintenance part 38 includes the collection tray 526 for collecting cleaning liquid and the like that have overflowed from the liquid application part 404. The collection tray 526 is divided into the first area 526a, which collects cleaning liquid and the like coming from the liquid application parts 404 corresponding to the print heads 36 that eject ink, and the second area 526b, which collects cleaning liquid and the like coming from the liquid application part 404 corresponding to the print head 36 that ejects reaction liquid. In other words, the collection tray 526 is configured so that the cleaning liquid collected in the first area 526a is not mixed with the cleaning liquid collected in the second area 526b.

The first area 526a is connected to the drain sub-tank 532. Further, the cleaning liquid collected in the first area 526a is transferred to the drain sub-tank 532 by the pump 538 installed between the collection tray 526 and the drain sub-tank 532. Moreover, the second area 526b is connected to the drain sub-tank 542. Further, the cleaning liquid collected in the second area 526b is transferred to the drain sub-tank 542 by the pump 548 installed between the collection tray 526 and the drain sub-tank 542.

The waste liquid reservoir part 40 includes a sensor (not illustrated in the drawings) that can detect the amounts of waste liquid stored in the waste ink tank 530 and the waste liquid tank 540. Further, based on the detection results of this sensor, the printing apparatus 10 provides a notification for prompting the user to replace the waste ink tank 530 and the waste liquid tank 540.

As described above, in the collecting channel for the waste liquid generated in the maintenance part 38, the waste ink including ink and cleaning liquid used for cleaning ink and the waste reaction liquid including reaction liquid and cleaning liquid used for cleaning reaction liquid are transferred to the waste ink tank 530 or the waste liquid tank 540 without mixing. This prevents the ink and the reaction liquid from reacting with each other in the collecting channel, causing the ink to solidify and block the channel.

### (Configuration of the Waste Liquid Reservoir Part)

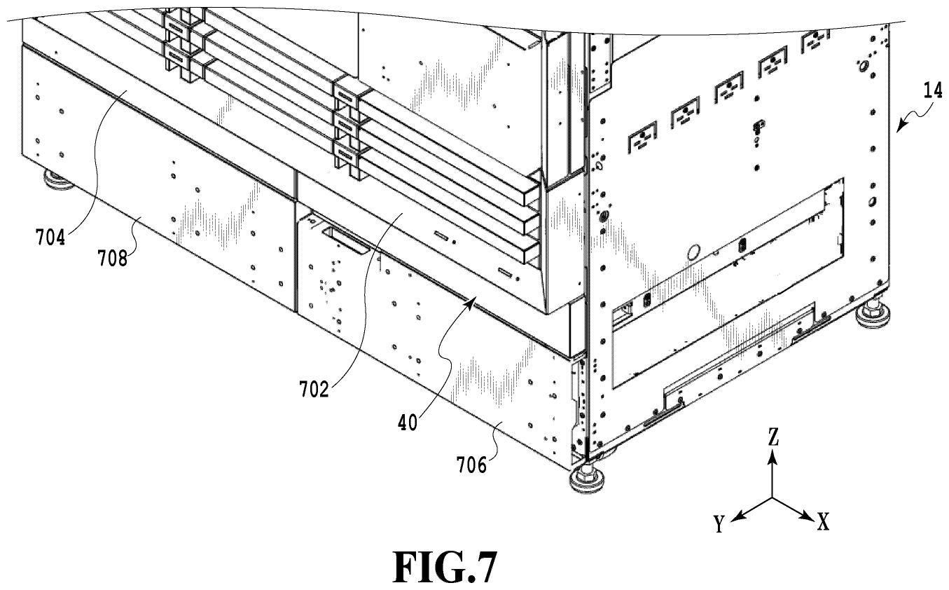

Next, an explanation is given about the configuration of the waste liquid reservoir part 40. FIG. 6 is a perspective configuration diagram of the waste liquid reservoir part 40 in the retracted position. FIG. 7 is a diagram illustrating the outer appearance of the printing apparatus 10 in the vicinity of the waste liquid reservoir part 40 located in the retracted position.

The waste liquid reservoir part 40 includes the tank tray 602 that supports the waste ink tank 530 and the waste liquid tank 540 from the lower side (see FIG. 6). The tank tray 602 includes the collection tray 526 with which, in a case where waste liquid leaks out from the supported waste ink tank 530 and waste liquid tank 540, the waste liquid that has leaked out is made to stagnate and collected. Note that the function of the collection tray 526 may be provided by the tank tray 602. Further, the waste liquid reservoir part 40 includes the rail 604 that supports the tank tray 602 in an approximately horizontal manner and supports the tank tray 602 between the retracted position and the replacement position in a movable manner. In the present embodiment, the tank tray 602 functions as a moving part that can move the waste ink tank 530 and the waste liquid tank 540 in the Y direction.

The waste liquid reservoir part 40 includes the cover member 606 on the other side of the tank tray 602 in the Y direction, i.e., on the front side. Further, the lower surface of the left side of the cover member 606 is formed with the handhold part 608 on which the user can hook his/her hand. The cover member 606 constitutes the outer casing of the printing apparatus 10 (the print module 14) at the time the waste liquid reservoir part 40 is in the retracted position. Note that, in the present specification, “the waste liquid reservoir part 40 is in the retracted position (replacement position)” is appropriately referred to as “the tank tray 602 is in the retracted position (replacement position)”.

Note that the outer casing of the front side of the print module 14 of the printing apparatus 10 includes the upper cover 702 located on the upper side of the waste liquid reservoir part 40 and the left cover 704 located on the left side of the waste liquid reservoir part 40 (see FIG. 7). Further, the outer casing includes the lower cover 706 located on the lower side of the waste liquid reservoir part 40 and the lower left cover 708 located on the left side of the lower cover 706 as well as the lower side of the left cover 704.

At the time the waste liquid reservoir part 40 is in the retracted position, the cover member 606 is positioned in an approximate alignment in the Y direction with the left cover 704, the lower cover 706, and the lower left cover 708. Further, at the time the waste liquid reservoir part 40 is in the retracted position, the upper cover 702 is located further on the other side, i.e., on the front side, in the Y direction relative to the cover member 606.

Further, at the time the waste liquid reservoir part 40 is in the retracted position, there is an interval in the Z direction between the cover member 606 and the lower cover 706. This allows the user to easily access the handhold part 608 installed on the lower surface of the cover member 606 in the waste liquid reservoir part 40 located in the retracted position, and to easily move the waste liquid reservoir part 40 in the Y direction from the retracted position.

The waste liquid reservoir part 40 includes the damper member 610 on the back side of the tank tray 602, so as to reduce the impact in contacting with a structure (not illustrated in the drawings) located on the back side of the waste liquid reservoir part 40 at the time the tank tray 602 is moved from the replacement position to the retracted position. Further, the waste liquid reservoir part 40 includes the retractor part 612 on the back side of the tank tray 602, so that, at the time the tank tray 602 is moved from the replacement position to the retracted position, the tank tray 602 that has moved to the vicinity of the retracted position can be pulled to the back side into the retracted position.

The waste liquid reservoir part 40 is installed between the waste ink tank 530 and the waste liquid tank 540, which are arranged side by side in the X direction in the tank tray 602, and includes the channel support member 614 that supports the channels connecting the drain sub-tanks, the waste ink tank, and the waste liquid tank. Specifically, the channel support member 614 supports the channel 630 connecting the drain sub-tank 532 and the waste ink tank 530 and the channel 640 connecting the drain sub-tank 542 and the waste liquid tank 540. Note that the channels 630 and 640 are assumed to be configured of flexible tubes, for example. Further, the channel support member 614 is configured to deform in accordance with the movement of the waste liquid reservoir part 40 in the Y direction, and configured to be capable of restricting the channel 630 and channel 640 from contacting with other constituent members in the deformed portion. In the present embodiment, the channel support member 614 functions as a support part that supports the channels 630 and 640 and can deform in accordance with the movement of the tank tray 602.

### (Configurations of the Waste Ink Tank and the Waste Liquid Tank)

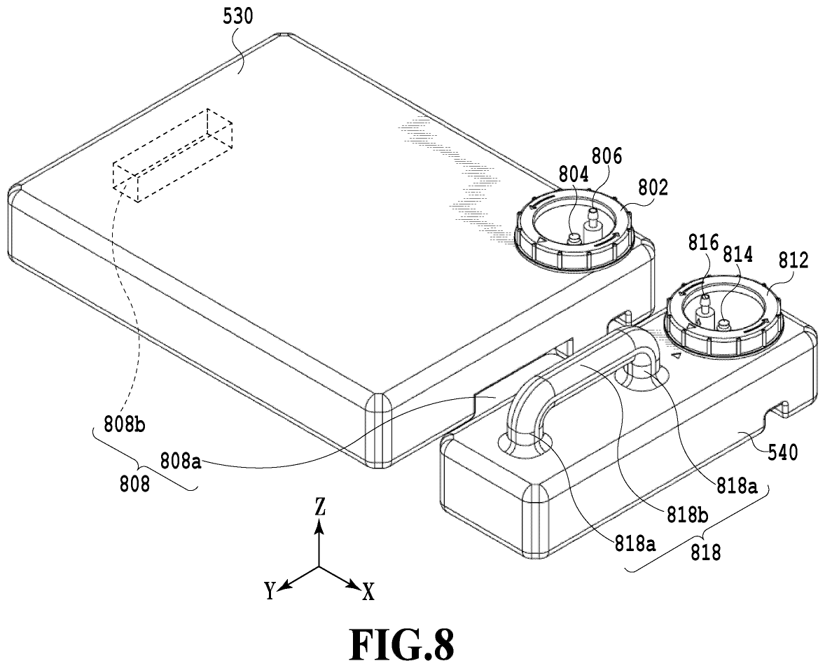

Next, an explanation is given about the configurations of the waste ink tank 530 and the waste liquid tank 540. FIG. 8 is a perspective view of the waste ink tank 530 and the waste liquid tank 540. In FIG. 8, the waste ink tank 530 and the waste liquid tank 540 are illustrated in their positions arranged in the waste liquid reservoir part 40.

The waste ink tank 530 and the waste liquid tank 540 are arranged side by side in the waste liquid reservoir part 40 with a predetermined interval in the X direction. The channel support member 614 is placed between the waste ink tank 530 and the waste liquid tank 540. In the present embodiment, the waste ink tank 530 has a larger capacity than the waste liquid tank 540.

### <Waste Ink Tank>

The tank cap 802 is mounted on the right back side of the waste ink tank 530 placed in the waste liquid reservoir part 40. Note that the tank cap 802 may be installed anywhere on the upper surface of the waste ink tank 530, but is determined in consideration of the position where the channel support member 614 is arranged, workability at the time of attaching and detaching the waste ink tank 530, and the like. In other words, if the waste liquid reservoir part 40 is configured as in the present embodiment, with such positioning on the right back side, the length of the channel 630 extending from the channel support member 614 can be shortened and the workability at the time of attaching and detaching the waste ink tank 530 is enhanced. Further, the tank cap 802 is formed with the connection port 804 connected to the channel 630 and the air communication port 806 that allows the inside of the waste ink tank 530 to communicate with the atmosphere. Thus, in the present embodiment, the tank cap 802 functions as a connecting member that can connect the waste ink tank 530 and the channel 630.

The waste ink tank 530 is formed with a pair of notch parts 808 that allows the user to grip and carry the waste ink tank 530. The pair of notch parts 808 includes the notch part 808a formed by notching a part of the right side surface and lower surface on the right side of the waste ink tank 530 and the notch part 808b formed by notching a part of the left side surface and lower surface on the left side of the waste ink tank 530. Note that the waste liquid stored in the waste ink tank 530 is disposed of from the waste ink tank 530 after the tank cap 802 is removed.

### <Waste Liquid Tank>

The tank cap 812 is mounted on the back side of the waste liquid tank 540 placed in the waste liquid reservoir part 40. Note that the tank cap 812 may be installed anywhere on the upper surface of the waste liquid tank 540, but is determined in consideration of the position where the channel support member 614 is arranged, workability at the time of attaching and detaching the waste liquid tank 540, and the like. In other words, if the waste liquid reservoir part 40 is configured as in the present embodiment, with such positioning on the back side, the length of the channel 640 extending from the channel support member 614 can be shortened and the workability at the time of attaching and detaching the waste liquid tank 540 is enhanced. The tank cap 812 is formed with the connection port 814 connected to the channel 640 and the air communication port 816 that allows the inside of the waste liquid tank 540 to communicate with the atmosphere. Thus, in the present embodiment, the tank cap 812 functions as a connecting member that can connect the waste liquid tank 540 and the channel 640.

The waste liquid tank 540 is formed with the handle part 818 that allows the user to grip and carry the waste liquid tank 540. The handle part 818 is placed on the upper surface of the waste liquid tank 540, and includes a pair of upright parts 818a, which is installed upright from the upper surface at a predetermined interval, and the connection part 818b, which connects the pair of upright parts 818a at their upper end portions. The user is to grip the connection part 818b and carry the waste liquid tank 540. Note that the waste liquid stored in the waste liquid tank 540 is disposed of from the waste liquid tank 540 after the tank cap 812 is removed. Further, it is preferable that the handle part 818 is designed to be positioned lower in the height direction than the channel support member 614 (the later-described body fixing part 906) on the waste liquid tank 540 placed on the tank tray 602.

The waste liquid tank 540 may have such a pair of notch parts as in the waste ink tank 530, instead of the handle part 818. Further, the waste ink tank 530 may have such a handle part as in the waste liquid tank 540, instead of the pair of notch parts 808. In this case, since the waste ink tank 530 extends in the X direction, there may be two handles installed at an interval in the X direction.

### (Configuration of the Channel Support Member)

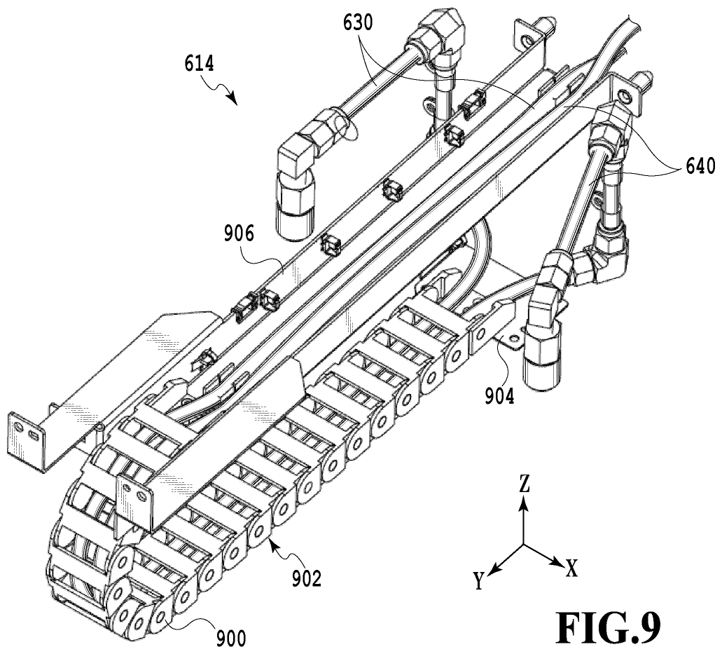

Next, an explanation is given about the configuration of the channel support member 614. FIG. 9 is a perspective configuration diagram of the channel support member 614.

The channel support member 614 includes the carrier part 902 that accommodates and protects the channels 630 and 640, which move as the tank tray 602 moves in the Y direction, while also supporting the channels 630 and 640 in a movable manner. Further, the channel support member 614 includes the tray fixing part 904 that fixes the carrier part 902 to the tank tray 602, and the body fixing part 906 located directly above the tank tray 602 in the retracted position to fix the carrier part 902 to the housing part of the printing apparatus 10.

The tray fixing part 904 is installed on the back side of the tank tray 602, and one end of the carrier part 902 is connected thereto. The body fixing part 906 extends in the Y direction and fixes the channels 630 and 640 in at least one position. Further, the other end of the carrier part 902 is connected to the front side of the body fixing part 906. Furthermore, the carrier part 902 extends to the front side from the tray fixing part 904 located on the lower side of the waste liquid reservoir part 40, then curves upward at a predetermined curvature and folds to the back side to connect to the body fixing part 906 located on the upper side of the waste liquid reservoir part 40. The predetermined curvature is, for example, a curvature at which the inserted channels 630 and 640 do not bend while the tank tray 602 moves in the Y direction.

The carrier part 902 is configured of multiple unit components 900 repeatedly linked and connected with pins. The channels 630 and 640 are inserted into each of the unit components 900. As the tank tray 602 is moved in the Y direction, the unit components 900 move from the upper position to the curved portion and to the lower position from the curved portion or move from the lower position to the curved portion and to the upper position from the curved portion with the carrier part 902 maintaining the predetermined curvature. Note that the upper position is the height position approximately in line with the main body fixing part 906, and the lower position is the height position approximately in line with the tray fixing part 904. Thus, in the present embodiment, the carrier part 902 functions as a deformable part that deforms as the tank tray 602 moves in the Y direction.

The channels 630 and 640 are guided from the back side of the body fixing part 906 toward the front side, and are inserted into the carrier part 902 at the front side of the body fixing part 906 and guided from the front side toward the back side. Further, the channel 630 guided to the back side by the carrier part 902 is guided diagonally to the left back side and then to the upper side from the vicinity of the back-side end of the tank tray 602. Thereafter, the channel 630 is guided to the front side or diagonally to the left front side, so as to be connected to the connection port 804 of the tank cap 802 at a height position approximately in line with the body fixing part 906. Further, the channel 640 guided to the back side by the carrier part 902 is guided diagonally to the right back side and then to the upper side from the vicinity of the back-side end of the tank tray 602. Thereafter, the channel 640 is guided to the front side or diagonally to the right front side, so as to be connected to the connection port 814 of the tank cap 812 at a height position approximately in line with the body fixing part 906.

### (Replacement of the Waste Ink Tank and the Waste Liquid Tank)

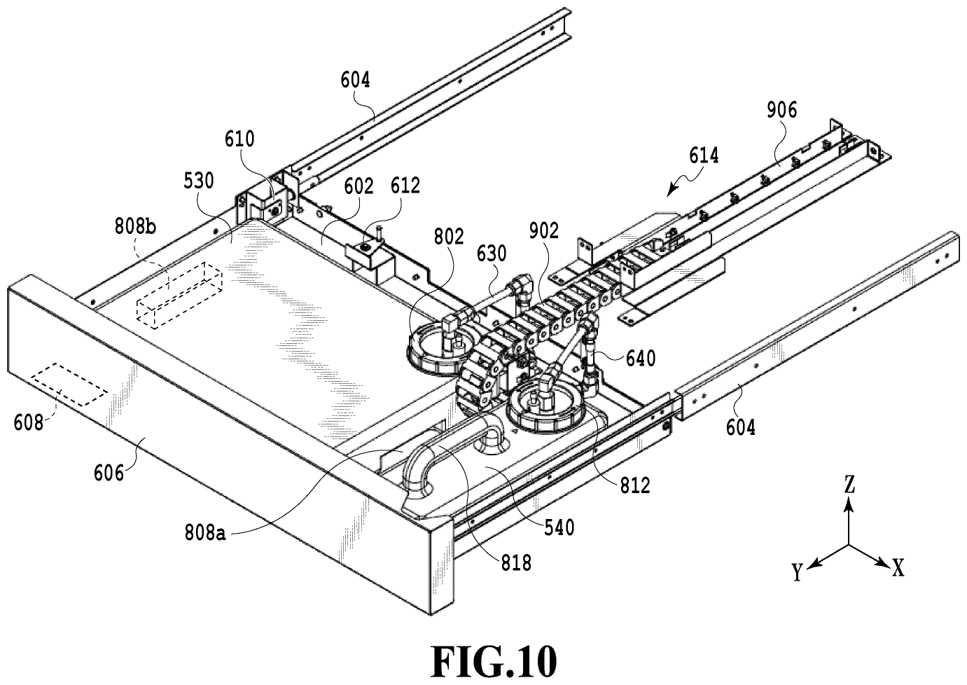

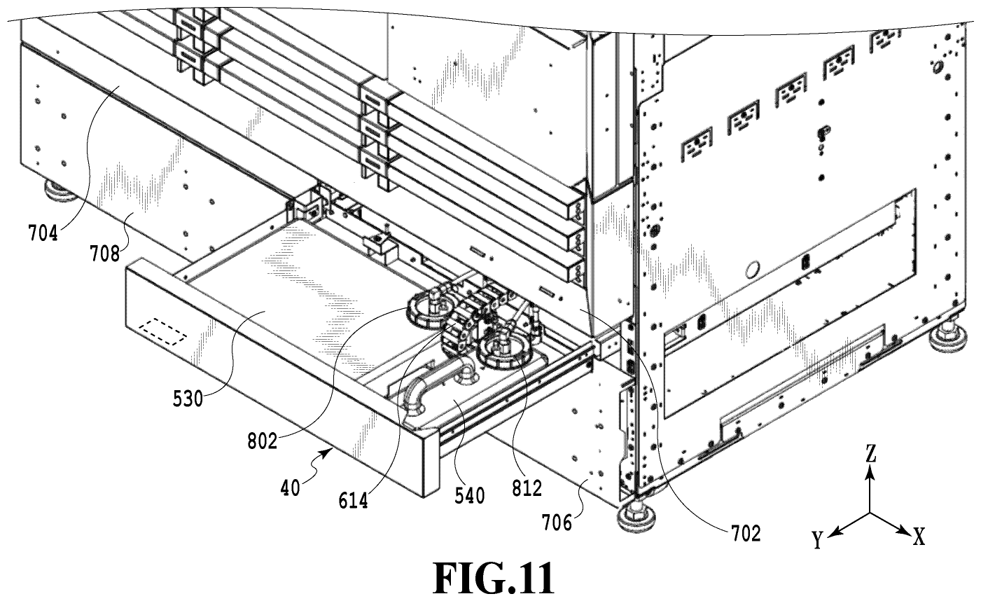

Next, an explanation is given about the replacement of the waste ink tank 530 and the waste liquid tank 540 in the waste liquid reservoir part 40. FIG. 10 is a perspective view of the waste liquid reservoir part 40 with the tank tray 602 being in the replacement position. FIG. 11 is a diagram illustrating the outer appearance of the printing apparatus 10 in the vicinity of the waste liquid reservoir part 40 with the tank tray 602 being in the replacement position.

At the time of replacing the waste ink tank 530 and the waste liquid tank 540, first, the tank tray 602 in the retracted position is pulled out to the replacement position. Specifically, the user hooks his/her hand on the handhold part 608 and pulls out the tank tray 602, which is in the retracted position, from the back side toward the front side. As the tank tray 602 moves from the back side to the front side, the carrier part 902 deforms in accordance with that movement while the channel support member 614 maintains the curvature of the curved portion of the carrier part 902. That is, the unit components 900 of the carrier part 902 located above the tank tray 602 (located at the lower position) (see FIG. 6) move in order from ones on the front side to the upper position via the curved portion (see FIG. 10).

At this time, in the waste liquid reservoir part 40, the upstream side of the channels 630 and 640 (the side where the pumps 536 and 546 are installed) is fixed to the body fixing part 906, and thus does not deform by that movement. On the other hand, in the waste liquid reservoir part 40, the downstream side of the channels 630 and 640 (the side where the waste ink tank 530 and the waste liquid tank 540 are installed) is inserted into the carrier part 902, and thus deforms in accordance with the deformation of the carrier part 902. A portion of the carrier part 902 is curved, and the other portions are linearly formed along the direction of the movement of the tank tray 602, and the carrier part 902 surrounds the channels 630 and 640. Therefore, the channels 630 and 640 do not come into contact with other constituent members nor bend due to the movement of the tank tray 602.

If the tank tray 602 is pulled out to the replacement position, next, the channel 630 of the waste ink tank 530 is removed from the connection port 804 of the tank cap 802, so that the waste ink tank 530 is removed from the tank tray 602. The user grips the pair of notch parts 808 in the waste ink tank 530 to remove the waste ink tank 530 from the tank tray 602. Note that the channel support member 614 is designed so that the carrier part 902 is positioned on the back side relative to the notch part 808a at the time the tank tray 602 is in the replacement position (see FIG. 10). Therefore, while the waste ink tank 530 is removed, the channel support member 614 is unlikely to come into contact with the user's hand, and thus damage to the channel support member 614 caused by contact with the user's hand is suppressed. Further, the channel 640 of the waste liquid tank 540 is removed from the connection port 814 of the tank cap 812, so that the waste liquid tank 540 is removed from the tank tray 602. The user grips the handle part 818 on the waste liquid tank 540 to remove the waste liquid tank 540 from the tank tray 602.

Note that the replacement position is where the waste ink tank 530 and the waste liquid tank 540 are easily removed from the tank tray 602. Specifically, while the tank tray 602 is in the replacement position, the waste ink tank 530 and the waste liquid tank 540 are located on the front side of the upper cover 702, which is formed to project to the front end in the vicinity of the waste liquid reservoir part 40 (see FIG. 11). In other words, the tank caps 802 and 812 are also located on the front side relative to the upper cover 702. Therefore, in the replacement position, the space above the left side of the waste ink tank 530 is wide open, and the space above the right side of the waste liquid tank 540 is wide open. Accordingly, in the job of attaching and detaching the waste ink tank 530 and the waste liquid tank 540 to and from the tank tray 602, including attaching and detaching the channels 630 and 640 to and from the connection ports 804 and 814, these members and the user's hands are unlikely to interfere with other constituent members of the printing apparatus 10. This allows the user to easily remove the waste ink tank 530 and the waste liquid tank 540 from the waste liquid reservoir part 40.

Note that, in the present embodiment, although the waste ink tank 530 and the waste liquid tank 540 in the replacement position are located on the front side relative to the upper cover 702, there is no limitation as such. In consideration of the sizes and shapes of the constituent members of the waste liquid reservoir part 40, each tank and the upper cover 702 may overlap in the Y direction in the replacement position as long as the job of attaching and detaching each tank to and from the tank tray 602 can be easily executed. The sizes and shapes of the constituent members of the waste liquid reservoir part 40 are, for example, the sizes and shapes of the waste ink tank 530, the waste liquid tank 540, the tank caps 802 and 812, and the tank tray 602 in the height direction.

Thereafter, a new waste ink tank 530 and waste liquid tank 540 are placed in the tank tray 602, and the channel 630 is connected to the connection port 804 of the tank cap 802 of the waste ink tank 530. Further, the channel 640 is connected to the connection port 814 of the tank cap 812 of the waste liquid tank 540. Furthermore, the user presses the cover member 606 to move the tank tray 602 in the replacement position to the retracted position.

### Functional Effect

As explained above, in the printing apparatus according to the present embodiment, in a tank tray which is movable in the Y direction, a waste liquid reservoir part that supports a tank for storing waste ink or the like includes a channel support member that supports a channel that guides waste ink or the like to the tank. The channel support member includes a body fixing part fixed to the housing of the printing apparatus, and a carrier part that can deform in a tank tray in accordance with the movement of the tank tray. The body fixing part fixes the channel on the upper side of the retracted position where the tank tray is retracted inside the apparatus. The carrier part extends from the body fixing part to the front side, and then curves and folds from the front side to the back side, so that the carrier part extends in an overlapping manner with the body fixing part in the direction of gravity (−Z direction) and is configured to be capable of internally accommodating the channel. Furthermore, at the time the tank tray is pulled out of the apparatus so that the waste liquid reservoir part is in the replacement position where the tank can be replaced, the tank is positioned on the front side relative to a cover member forming the outer casing of the apparatus in the vicinity of the waste liquid reservoir part.

Accordingly, the tank to be replaced can be positioned outside of the apparatus during the tank replacement job, and thus the space on the upper side of the tank tray is widely available. This prevents the user's hands and the tank to be replaced from contacting with other constituent members of the printing apparatus, thereby improving workability at the time the user replaces the tank and preventing damage to the constituent members by the tank or hands. Furthermore, even in a case where ink that easily solidifies upon contact with the atmosphere is used, the members with such solidification can be easily replaced since the configurations that come into contact with the atmosphere during replacement will also be located outside.

Further, at the time of moving the tank tray to the retracted position or the replacement position, the channel support member prevents the channel from making contact with other constituent members or from bending, etc. This can suppress the leakage of waste ink inside the apparatus. Furthermore, by making the channel support member approximately the same size as the tank in the height direction (the Z direction), the waste liquid reservoir part can be made smaller in the height direction. Further, in the present embodiment, since the channel support member is configured to support two channels, the waste liquid reservoir part is downsized compared to a configuration in which each of the two channels is supported by a different channel support member.

### Other Embodiments

Note that the above-described embodiment may be modified as shown in the following (1) through (7).

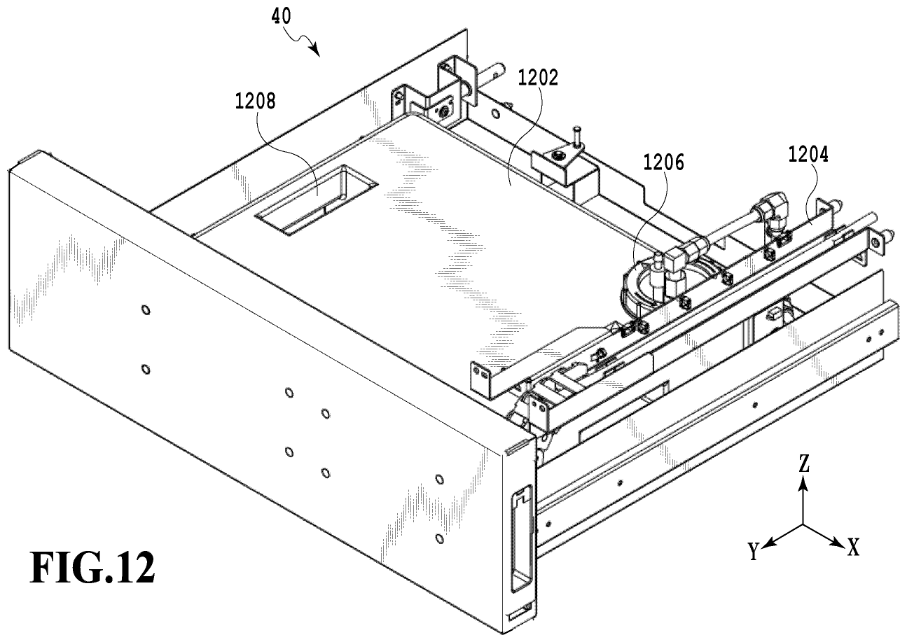

(1) In the above-described embodiment, the waste liquid reservoir part 40 includes the waste ink tank 530 and the waste liquid tank 540, but there is no limitation as such. For example, in a case where the printing apparatus 10 is configured not to eject reaction liquid, the waste liquid reservoir part 40 includes one waste ink tank 1202 as illustrated in FIG. 12. In this case, the channel support member 1204 extends along the Y direction on the side where the tank cap 1206 of the waste ink tank 1202 is installed in the X direction (the right side in FIG. 12).

(2) In the above-described embodiment, the waste ink tank 530 is configured so that the pair of notch parts 808 formed by notching a part of the lower surface and left and right side surfaces can be gripped, and the waste liquid tank 540 is configured so that the handle part 818 installed upright on its upper surface can be gripped, but there is no limitation as such. Various known technologies can be used for the configuration of the gripping part that can be gripped in the waste ink tank 530 and the waste liquid tank 540. For example, as in FIG. 12, the tank may be equipped with the handhold part 1208 on its upper surface so that the user can hook his/her hand and pull up the tank.

(3) In the above-described embodiment, the two channels 630 and 640 are configured to be supported by one channel support member 614, but there is no limitation as such. The channels 630 and 640 may be configured to be supported by different channel support members. In this case, the channel support members need not be placed between the waste ink tank 530 and the waste liquid tank 540. For example, the channel support member that supports the channel 630 may be placed on the left side of the waste ink tank 530. Note that, in this case, it is preferable that the tank cap 802 of the waste ink tank 530 is installed on the left back side of the upper surface of the waste ink tank 530. Further, the channel support member that supports the channel 640 may be placed on the right side of the waste liquid tank 540.

(4) In the above-described embodiment, the positioning mechanisms for the caps 304, the liquid application parts 404, the removal parts 406, and the negative pressure application parts 408, etc., to be positioned with respect to the print heads 36 are configured with concave parts and convex parts to be engaged with each other, but there is no limitation as such. For example, it is also possible that such a configuration as an butting part installed in the print heads 36 abuts on a predetermined position of the cap part 302 and the cleaning part 402 for the positioning. Alternatively, the print heads 36 may be positioned for the cap part 302 and cleaning part 402 by inserting a pin installed on one of them to a hole installed on the other one of them.

(5) Although not specifically described in the above embodiment, the present invention is not limited to application to a waste liquid reservoir part that stores waste ink and waste reaction liquid. That is, application to a configuration that stores ink to be supplied to a print head is also possible. For example, an ink reservoir part with four ink tanks storing different types of ink that are arranged side by side in the X direction in a tank tray that is movable in the Y direction is taken as an example. In this case, for example, the first channel support member is placed between the first ink tank and second ink tank from the right side to support the first channel for supplying ink from the first ink tank and the second channel for supplying ink from the second ink tank. Further, the second channel support member is placed between the third ink tank and fourth ink tank from the right side to support the third channel for supplying ink from the third ink tank and the fourth channel for supplying ink from the fourth ink tank. In this case, ink is supplied to the corresponding print heads via the channels supported by the first channel support member and the second channel support member.

(6) In the above-described embodiment, the printing apparatus 10 is configured to eject ink and reaction liquid that reacts with the ink, but there is no limitation as such. The printing apparatus 10 may be configured with the ability of ejecting various types of liquids, such as, for example, a coating liquid to protect the printing surface or other processing liquid to apply a predetermined treatment to the print media after printing.

(7) The above-described embodiment and various forms shown in (1) through (6) may be combined as appropriate.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-115851, filed Jul. 14, 2023, which is hereby incorporated by reference wherein in its entirety.

What is claimed is:

1. A printing apparatus that performs printing by ejecting liquid to a print medium, the printing apparatus comprising:
a printing unit configured to eject the liquid;
a storage unit configured to store the liquid;
a moving unit on which the storage unit is placed in a replaceable manner, and which is configured to be movable between a replacement position, where the storage unit can be replaced, and a retracted position, where the storage unit is retracted inside the printing apparatus; and
a support unit configured to support a channel connected to the storage unit, and configured to be deformable in accordance with movement of the moving unit,
wherein the support unit includes
a fixing part that extends in a movement direction of the moving unit and is fixed to the printing apparatus and
a deformable part of which one end is connected to the fixing part and the other end is fixed to the moving unit, the deformable part being configured to extend from one side to the other side of the movement direction and then curve at a predetermined curvature and fold from the other side to the one side, so as to extend in an overlapping manner with the fixing unit in a direction of gravity.

2. The printing apparatus according to claim 1,
wherein the deformable part is configured with unit components linked with a pin.

3. The printing apparatus according to claim 1,
wherein, in the storage unit, a connection member that can be connected to the channel is located on one side of the movement direction.

4. The printing apparatus according to claim 3,
wherein the connection member is located on a side where the support unit of the storage unit is located.

5. The printing apparatus according to claim 1,
wherein the storage unit stores the liquid to be ejected to the print medium, and
wherein the liquid stored in the storage unit is supplied via the channel to the printing unit.

6. The printing apparatus according to claim 1,
wherein the storage unit stores waste liquid generated in a recovery operation performed for the printing unit, and
wherein the waste liquid is transported to the storage unit via the channel.

7. The printing apparatus according to claim 1,
wherein the storage unit includes a first storage unit configured to store a first liquid and a second storage unit configured to store a second liquid, and
wherein, in the movement direction, the first storage unit and the second storage unit are arranged side by side in a direction intersecting with the movement direction of the moving unit.

8. The printing apparatus according to claim 7,
wherein, between the first storage unit and the second storage unit, the support unit supports a first channel connected to the first storage unit and a second channel connected to the second storage unit.

9. The printing apparatus according to claim 7,
wherein the support unit includes
a first support unit configured to support a first channel connected to the first storage unit and
a second support unit configured to support a second channel connected to the second storage unit.

10. The printing apparatus according to claim 7,
wherein the printing unit includes
a first printing unit configured to eject the first liquid; and
a second printing unit configured to eject the second liquid,
wherein the first liquid is ink to be supplied to the first printing unit, and
wherein the second liquid is reaction liquid that reacts with the ink and is supplied to the second printing unit.

11. The printing apparatus according to claim 7,
wherein the printing unit includes
a first printing unit configured to eject ink; and
a second printing unit configured to eject reaction liquid that reacts with the ink,
wherein the first liquid includes waste ink generated in a recovery operation performed for the first printing unit, and
wherein the second liquid includes waste reaction liquid generated in a recovery operation performed for the second printing unit.

12. The printing apparatus according to claim 1,
wherein, in the replacement position, the storage unit does not overlap with an outer casing of the printing unit in the movement direction of the moving unit.

13. The printing apparatus according to claim 1,
wherein the storage unit includes a grip part that can be gripped.

14. The printing apparatus according to claim 13,
wherein the grip part is a notch part formed by notching a part of a side surface and lower surface of the storage unit.

15. The printing apparatus according to claim 14,
wherein, in the replacement position, the grip part does not overlap with the support unit in the movement direction of the moving unit.

16. The printing apparatus according to claim 13,
wherein the grip part is a handle part installed upright on an upper surface of the storage unit.

17. The printing apparatus according to claim 13,
wherein the grip part is a handhold part installed on an upper surface of the storage unit for hooking a hand for carrying the storage unit.
